(19) United States
(12) Patent Application Publication
(10) Pub. No.: US 2018/0266605 A1
(43) Pub. Date: Sep. 20, 2018

(54) CONNECTOR ASSEMBLY

(71) Applicant: HYDRASUN LIMITED, Aberdeen (GB)

(72) Inventor: Jonathan Hill, Glasgow (GB)

(73) Assignee: HYDRASUN LIMITED, Aberdeen (GB)

(21) Appl. No.: 15/919,348

(22) Filed: Mar. 13, 2018

(30) Foreign Application Priority Data
Mar. 15, 2017 (GB) 1704090.8

(51) Int. Cl. F16L 37/10

(52) U.S. Cl. CPC F16L 37/10; E21B 41/00

(57) ABSTRACT

A kit including a central adaptor (10) and interchangeable terminators (40) that are configured to connect two separate lines via the central adaptor (10) is described. The central adaptor (10) comprises two end connectors (20) onto which first and second terminators (40) are coupled, and the first and second lines are then coupled to the respective terminators (40) such that the lines are in fluid communication with each other. The lines may be of different diameters. The terminators (40) contained within the kit comprise a range of diameters, thereby facilitating connection of a respective range of lines.

The present application relates generally to an apparatus and method, and particularly to a connector assembly and to a method of securely and rapidly connecting two separate high-pressure lines where one line is a different size (typically diameter) and/or thread type to the other line.

### BACKGROUND

In many industries such as in an offshore environment, for example subsea or topside on an oil rig or FPSO, the option to rapidly and securely connect the interface or connection provided on the end of pressurised fluid-carrying lines (such as hoses, pipes, or other equipment) of different sizes in a sealed manner is valuable as a means of reducing downtime and costs. In order to achieve this, the user must either have a “library” of connecting adaptors with a variety of thread and diameter combinations, or order the required fitting, with the associated lead time for delivery. In some cases, bespoke adaptors may need to be made for the user, resulting in greater delay.

In many offshore environments the lines, and more particularly the interface or connection on the end thereof, may have multiple different end terminations, which means that thousands of different adaptors are required to cover all possible combinations. It has been known for operators to bridge the gap between two or more lines by connecting a number of different adaptors in series, thereby making the transition from one line diameter or type to another via two or more adaptors, however, that solution is sub-optimal for many reasons, including multiple leak paths and the weight of the string of adaptors causing strain and damage to the adaptors. The strain and damage can lead to a high risk of leakage of fluid from the lines, resulting in unpredictable levels of fluid pressure, environmental damage, and potential health and safety risks.

### SUMMARY

According to a first aspect of the present invention, there is provided a connector assembly for connecting at least two separate lines together in fluid communication, the connector assembly comprising a central adaptor having a bore therethrough, and at least two terminators, each terminator having a bore therethrough; wherein the central adaptor comprises at least a first end connector and a second end connector, the first and second end connectors being spaced from one another, each end connector being adapted to connect to a terminator, wherein each terminator is adapted to permit the connector assembly to be connected with at least said two separate lines such that the said at least two lines are in fluid communication when the connector assembly is made up.

Typically the central adaptor has a body with an axis. Typically the terminator has a body with an axis. Optionally the axes of the central adaptor and one or more terminators are coincident.

Optionally the at least first and second end connectors are axially spaced from one another. Optionally the end connectors may be spaced from one another within the same or different planes and at an acute, right, or obtuse angle relative to one another.

Preferably the end connectors of the central adaptor are male and adapted to be received within a bore of a female end of each terminator. Alternatively, the end connectors of the central adaptor are female and are adapted to receive a male end of each terminator.

Optionally each end connector comprises a movable sleeve adapted to slide axially over the body of the central adaptor. Optionally the central adaptor further comprises at least one resilient device adapted to bias the movable sleeves into a resting configuration. Optionally the resilient device biases the movable sleeves in a direction away from the axial centre of the central adaptor body. Preferably, the central adaptor comprises one resilient device disposed between the movable sleeves and mutually acting on each movable sleeve.

Optionally the axial travel of the movable sleeve is limited in at least one direction by a retaining device such as a retaining ring, optionally disposed within an annular groove on the outer surface of the central adaptor body. Optionally the retaining ring is integrally formed on the outer surface of the central adaptor body. Optionally the movable sleeve is held between the retaining ring on one side of the movable sleeve and the resilient device on the other slide of the movable sleeve. Optionally the movable sleeve has at least one annular recess, optionally two, wherein the or each annular recess is adapted to receive the retaining ring and/or at least a portion of the resilient device. Optionally the retaining ring associated with one movable sleeve may be differently arranged and/or dimensioned to the retaining ring associated with the other movable sleeve or movable sleeves in order to aid assembly of the central adaptor. For example, one of the retaining rings may be a circlip that is adapted to be positioned on the body of the central adaptor once the movable sleeve or sleeves and the resilient device have been put into place on the central adaptor. Optionally the or each movable sleeve is adapted to rotate around the body of the central adaptor. Optionally the or each movable sleeve is rotationally locked in position and can only move in an axial direction.

Optionally the terminators, the movable sleeves, and the central adaptor are manufactured from the same material, optionally metal, for example steel, or optionally plastic, or optionally composite materials. Optionally one or more components are made from a different material than the others, for example where electrical discontinuity is required, and hence for some applications non-conductive materials may be used. Optionally, the central body may be manufactured from flexible material that allows the central body, and optionally other components of the connector assembly, to flex under rotational and/or axial strain.

Optionally each terminator comprises a connecting portion, optionally a threaded portion adapted to connect the interface or connection of a line to the central adaptor when the connector assembly is made up. The lines may be, for example, fluid transport lines operating at high pressure, e.g. hydraulic or pneumatic lines. Alternatively the terminators are not threaded, and connect a line to the central adaptor in a different manner. Some examples of alternative connection types include, but are not limited to, temporary weld joints, push-fit connections, compression fittings, valved connections, or flange fittings. Optionally the terminators are disposed within the end of a line, such that the connection of the terminator and the line to the central adaptor is a single step. This arrangement offers the advantage that the lines are then restricted to connecting with the central adaptor only, and can be used, for example, as a test line.

Preferably the connections between the end connectors and the terminators are of a bayonet style, that is, the terminators are pushed onto the end connectors and rotated. Advantages of a bayonet-style fitting include, for example, prevention of overtorquing of the connection causing damage to threads and risking unexpected disconnection under axial loading.

Alternatively, and less preferred, the connections between the end connectors and the terminators are threaded. Optionally the female portion of one of the terminator or the end connectors is received within the male portion of the other of the terminator or the end connectors and is torqued up.

Optionally the end of the terminator that connects to the line or hose may be angled at 0-90° relative to an axis of the central adaptor, for example a longitudinal axis of the central adaptor. This is useful in cases where an elbow fitting would be required.

Optionally, where the terminator comprises the male portion and the end connector is female, the central adaptor optionally comprises a semi-annular radially protruding ridge formed in the body of the central adaptor that optionally extends partially around the circumference of the end connector. Optionally the terminator comprises at least one axially-extending tab comprising a complementary semi-annular grooved section on an inner surface. Optionally the at least one tab of the terminator is adapted to fit into at least one cut-out in a protruding annular portion of the movable sleeve.

In one example, where the terminator comprises the male portion and the end connector is female, the male portion of the end connector is inserted axially into the bore of the female portion of the terminator to begin connection. Optionally the terminator is slid onto the end connector, optionally aligned so that the semi-annular radially protruding ridge or ridges on the central adaptor are positioned between two axially-extending tabs formed on the terminator. Optionally as the terminator is pushed onto the connector, the movable sleeve can be moved axially away from the end connector, optionally towards the centre of the central adaptor, optionally against the biasing force of the resilient device. Optionally the resilient device is a spring, optionally a wave spring or a coil spring, but other biasing means may be effectively used. Optionally, retraction of the movable sleeve provides additional axial space onto which the terminator can be pushed, optionally until the distal end of the male portion of the end connector is fully inserted into the bore of the terminator. Optionally the movable sleeve is retracted manually. Optionally the movable sleeve may be retracted by, for example, hydraulic pressure or pistons. Optionally the movable sleeve is pushed back by the terminator as it is connected to the central adaptor.

Optionally the terminator is rotated relative to the body of the central adaptor such that the semi-annular groove on the inner surface of the tab of the terminator rotates over the semi-annular ridge on the body of the central adaptor. The inter-engagement of the ridge and groove optionally locks the terminator in the axial direction to resist disconnection of the terminator from the central adaptor.

Optionally the movable sleeve is then released and returns to its initial configuration, optionally under the force of the resilient device. Optionally the at least one axially-extending tab of the terminator is aligned with the at least one cut-out in the movable sleeve such that as the movable sleeve returns to its original resting configuration, the tab slides into the cut-out. This optionally rotationally locks the terminator so that it does not rotate relative to the central adaptor body.

Optionally each terminator has at least one flat portion extending longitudinally within the bore of the female terminator. Optionally, where the terminators are male, the flat portion is machined into the outer surface of each terminator. Optionally the end connector has a corresponding flat portion machined into its outer surface, where the end connector is male, or within its bore, where the end connector is female. Optionally, the at least one flat portion of each of the terminator and the end connector engage with each other. Optionally the flat portions act to restrict relative rotation of the end connectors and the terminators, and may optionally assist with guiding the terminators onto the end connectors in alignment with the at least one cut-out in the movable sleeve.

Accordingly, once the terminator has been fitted to the central adaptor as described above, both axial and rotational movement of the terminator relative to the central adaptor is restricted and axial and rotational movement is reduced if required. Alternatively, the terminators may be free to rotate relative to the central adaptor in some examples of the invention, for example to ease connection or to avoid torsion in connected lines.

Optionally each terminator has at least one sealing device disposed on an inner surface of the bore of the female connector adapted to safely retain the pressurised fluids inside the connector assembly and seal against ingress of fluid or debris. Optionally the sealing device or devices are disposed on a surface of the end connector. Optionally there are sealing devices on both the end connector and the terminators. Optionally the sealing devices are 0-rings, or any other suitable sealing device. Optionally the 0-ring is positioned adjacent to or between secondary seals which act to protect the 0-ring from damage and reduce extrusion of the 0-ring into the space between the outer surface of the end connector and the inner surface of the bore of the terminator.

Optionally a locking device may be placed between the movable sleeves of each end connector to resist axial movement of the sleeves, and thereby prevent accidental disconnection of the terminators. The locking device may, for example, be a semi-annular ring adapted to clip over the resilient device, between the movable sleeves. The ring may optionally be made of plastic. The ring may have a central groove adapted and dimensioned to receive, for example, a cable tie, in order to provide additional security to resist removal of the plastic ring. Alternatively, the locking device may be a clamp which clamps over the resilient device. Additional reinforcement of this may be provided in the form of a padlock or similar lock to resist the clamp disconnecting. For example, the clamp may have two halves, wherein one half comprises an extending tongue at one end with an aperture therethrough, where the tongue is received into a slot at the end of the other half of the clamp, the slot having apertures through each side. The apertures in the tongue and the slot may line up and permit the insertion of a shackle through said apertures to resist the tongue moving out of the slot.

Optionally the connector assembly can be used for lines communicating at high pressures of fluids, i.e. liquids and/or gases. Optionally the connector assembly can be used for lines pressured up to 10,000 psi (approximately 69 MPa). Optionally the connector assembly can be used for lines pressured up to 15,000 psi (approximately 103 MPa), but this is not limiting and the invention may be used at higher or lower pressures.

According to a second aspect of the present invention there is provided a kit comprising a connector assembly for connecting at least two separate lines together in fluid communication, the connector assembly comprising:
a central adaptor having a bore therethrough; and
at least two terminators, each terminator having a bore therethrough;
wherein the central adaptor comprises at least a first end connector and a second end connector, the at least first and second end connectors being spaced from one another, each end connector being adapted to connect to a terminator;
wherein each terminator is adapted to permit the connector assembly to be connected with said at least two separate lines such that the said lines are in fluid communication when the connector assembly is made up; and
wherein the kit comprises at least one said central adaptor and at least three said terminators.

The kit is optionally supplied in a single protective container such as a case, box, or tool chest. Optionally the kit is compact and can be transported by a single user. More preferably the kit can comprise at least one central adaptor and three or more terminators. Where the connector assembly is part of a kit, each terminator comprises a standard first coupling on one side, allowing each terminator to be connected on either side of the central adaptor, and each terminator of the plurality of terminators comprises an optionally unique (within the kit) second coupling on another side of the terminator, optionally on the axially opposite side to the first coupling. Optionally, the second coupling may be perpendicular to the first coupling. Optionally the second coupling may be at an angle between 0°-90° relative to the longitudinal axis of the central adaptor.

Optionally the kit includes at least one whip hose or similar conduit which may provide an extension between the end of the line to be connected and the connector assembly.

In providing multiple terminators, each with a different coupling, a large number of combinations of connections can be made from one comparatively small kit, removing the need to hold a large number of adaptors in situ, and allowing a connection to be made up while the user waits for delivery of a bespoke adaptor. The kit also removes the need to connect several adaptors in series to arrive at the correct diameter, thread type, and adaptor required to connect two lines, which can result in each adaptor experiencing significant strain as a result of the weight of the adaptor string, and can also give rise to multiple leak paths through the string.

The number of potential combinations can be calculated as follows:

n=number of different terminators in the kit

r=number of terminators that will be combined (for a double-ended central adaptor, this is always 2)

ₙCᵣ=n!/r!(n−r)! (1)

Hence for a kit with a single double-ended adaptor and 20 terminators, there are

ₙCᵣ20!/ 2!(20−2)!=190 possible combinations.

For a kit with 49 terminators, the number of possible combinations is 1176.

Typically a kit will comprise at least 3 terminators, for example smaller kits may comprise between 10 and 50 terminators, and larger kits may comprise more than 50 terminators.

The present application also discloses a method of connecting at least two separate lines having different internal diameters and/or connection profiles to each other, the method including providing a connector assembly for connecting said at least two separate lines together in fluid communication, the connector assembly comprising a central adaptor having a bore therethrough, and at least two terminators, each terminator having a bore therethrough; wherein the central adaptor comprises at least a first end connector and a second end connector, the first and second end connectors axially spaced from one another; connecting each end connector to a terminator to make up the connector assembly; and connecting each terminator of the connector assembly with a respective line such that the said at least two separate lines are in fluid communication.

Optionally the connections between the first and second end connectors and the terminators are bayonet connections.

Optionally the central adaptor comprises at least first and second movable sleeves.

Optionally the method includes axially moving a movable sleeve over the central adaptor, optionally an outer surface of the central adaptor. Optionally the movable sleeve is moved between an initial first configuration, and a second configuration. Optionally the central adaptor comprises a resilient device which is optionally disposed between the movable sleeves. Optionally the second configuration of the movable sleeve is one in which the resilient device is energised. Optionally movement of the movable sleeve into the second configuration moves the movable sleeve axially away from the end connector. Optionally the resilient device applies a biasing force against the movable sleeve. Optionally the movable sleeve is moved against the biasing force of a resilient device. Optionally the resilient device is energised by moving the movable sleeve against it. Optionally the movable sleeve is held in the energised position during connection of the terminator to the end connector.

Optionally the method includes pushing a terminator axially onto a respective end connector and rotating said terminator into an engaged configuration wherein relative axial movement of the terminator and the central adaptor is restricted. Optionally the method includes engaging the terminator with the end connector by rotating the terminator until a radially protruding ridge on an outer surface of the central adaptor is engaged into a complementary groove on an inner surface of the terminator.

Optionally the method includes engaging at least two terminators with at least two axially spaced end connectors on the body of the central adaptor, and locking said terminators into position relative to the end connectors, such that axial and rotational movement of said terminators relative to the end connectors is restricted.

Optionally the terminator is axially slid over or into the end connector. Optionally the terminator comprises at least one groove, optionally with at least one lip at one side of the groove. Optionally the end connector comprises at least one radially and partially circumferentially extending tab or ridge that is optionally arranged to engage within the at least one groove of the terminator, optionally by rotating the terminator over the ridge. Optionally the terminator is partially rotated by a distance of e.g. 30°-120°. Optionally the lip of the groove on the terminator restricts relative movement of the terminator and the end connector in an axial direction. Optionally one of the terminator and the movable sleeve comprises at least one axially-extending tab. Optionally one of the terminator and the movable sleeve comprises at least one cut-out sized to receive the at least one axially-extending tab on the other of the terminator or the movable sleeve. Optionally after rotation of the terminator and inter-engagement of the groove and ridge, the movable sleeve is returned to the first configuration. Optionally as the movable sleeve returns to the first configuration, optionally under the force of the resilient device, the axially-extending tab of one of the terminator and the movable sleeve slides into the cut-out in the other of the terminator and the movable sleeve, optionally thereby resisting relative rotation of the components.

Optionally each terminator is connected to a line, optionally threaded into the line, and optionally a connection is formed across the connector assembly. Optionally the line connected to one terminator is a different diameter to the line connector to another terminator in the connector assembly.

Optionally the method includes providing the connector assembly in a kit within a protective case, wherein the kit comprises one central adaptor and at least three terminators. Optionally the kit comprises at least 3 terminators, optionally between 10 and 50 terminators, or optionally between 10 and 100 terminators.

Preferably the terminators in the kit comprise a range of diameters and/or connection types for connection with a respective range of lines and more preferably there are no more than two terminators in each kit having the same diameter and/or connection type, and most preferably, each terminator in a kit is unique.

The various optional features of the connector assembly as defined above can be used with the method.

The various aspects of the present apparatus and method can be practiced alone or in combination with one or more of the other aspects, as will be appreciated by those skilled in the relevant arts. The various aspects of the present apparatus and method can optionally be provided in combination with one or more of the optional features of the other aspects of the present apparatus and method. Also, optional features described in relation to one aspect can typically be combined alone or together with other features in different aspects of the present apparatus and method. Any subject matter described in this specification can be combined with any other subject matter in the specification to form a novel combination.

Various aspects of the present apparatus and method will now be described in detail with reference to the accompanying figures. Still other aspects, features, and advantages of the present apparatus and method are readily apparent from the entire description thereof, including the figures, which illustrates a number of exemplary aspects and implementations. The present apparatus and method is also capable of other and different examples and aspects, and its several details can be modified in various respects, all without departing from the scope of the present apparatus and/or method as defined by the claims. Accordingly, each example herein should be understood to have broad application, and is meant to illustrate one possible way of carrying out the present apparatus and method, without intending to suggest that the scope of this disclosure, including the claims, is limited to that example. Furthermore, the terminology and phraseology used herein is solely used for descriptive purposes and should not be construed as limiting in scope. Language such as “including”, “comprising”, “having”, “containing”, or “involving” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Thus, throughout the specification and claims unless the context requires otherwise, the word “comprise” or variations thereof such as “comprises” or “comprising” will be understood to imply the inclusion of a stated integer or group of integers but not the exclusion of any other integer or group of integers.

Any discussion of documents, acts, materials, devices, articles and the like is included in the specification solely for the purpose of providing a context for the present apparatus and method. It is not suggested or represented that any or all of these matters formed part of the prior art base or were common general knowledge in the field relevant to the present apparatus and method.

In this disclosure, whenever a composition, an element or a group of elements is preceded with the transitional phrase “comprising”, it is understood that we also contemplate the same composition, element or group of elements with transitional phrases “consisting essentially of”, “consisting”, “selected from the group of consisting of”, “including”, or “is” preceding the recitation of the composition, element or group of elements and vice versa. In this disclosure, the words “typically” or “optionally” are to be understood as being intended to indicate optional or non-essential features of the present apparatus and method which are present in certain examples but which can be omitted in others without departing from the scope of the present disclosure.

All numerical values in this disclosure are understood as being modified by “about”. All singular forms of elements, or any other components described herein are understood to include plural forms thereof and vice versa. References to directional and positional descriptions such as upper and lower and directions e.g. “up”, “down” etc. are to be interpreted by a skilled reader in the context of the examples described to refer to the orientation of features shown in the drawings, and are not to be interpreted as limiting the present apparatus and method to the literal interpretation of the term, but instead should be as understood by the skilled addressee.

### BRIEF DESCRIPTION OF THE DRAWINGS

Embodiments of the present invention will now be described, by way of example only, with reference to the accompanying drawings, in which:

FIG. 1 shows a perspective three dimensional view of a made up connector assembly in accordance with the present invention, having a central adaptor and first and second terminators;

FIG. 2 shows a schematic view of one end of the connector assembly of FIG. 1, with the cross-sectional lines labelled A corresponding to the cut-away sections of FIG. 3;

FIG. 3 shows a schematic part cut-away side view of the connector assembly of FIG. 1;

FIG. 4 shows a perspective part cut-away view of the connector assembly first shown in FIG. 1 but now with a first terminator connected and a second terminator uncoupled from the central adaptor;

FIG. 5 shows a schematic end view of the connector assembly of FIG. 4, with the cross-sectional lines labelled G corresponding to the cut-away sections of FIGS. 4 and 6;

FIG. 6 shows a schematic part cut-away side view of the connector assembly of FIG. 4;

FIG. 7 shows a part perspective cut-away view of the connector assembly first shown in FIG. 1 but now with the second terminator in an initial pre-engagement location with a respective end connector of the central adaptor;

FIG. 8 shows a schematic end view of the connector assembly of FIG. 7, with the cross-sectional lines labelled H corresponding to the cut-away sections of FIGS. 7 and 9;

FIG. 9 shows a schematic part cut-away side view of the connector assembly of FIG. 7;

FIG. 10 shows a perspective part cut-away view of the connector assembly first shown in FIG. 1 but now with the second terminator engaged with its respective end connector of the central adaptor, showing the next stage on from FIG. 7 of the connection of the second terminator to its respective end connector of the central adaptor;

FIG. 11 shows a schematic end view of the connector assembly of FIG. 10, with the cross-sectional lines labelled J corresponding to the cut-away sections of FIGS. 10 and 12;

FIG. 12 shows a schematic part cut-away side view of the connector assembly of FIG. 10;

FIG. 13 shows a perspective part cut-away view of the connector assembly first shown in FIG. 1 but now with the second terminator pushed onto the end connector, thereby showing the next stage on from FIG. 10 of the connection of the second terminator to its end connector;

FIG. 14 shows a schematic end view of the end connector of FIG. 13, with the cross-sectional lines labelled K corresponding to the cut-away sections of FIGS. 13 and 15;

FIG. 15 shows a schematic part cut-away side view of the connector assembly of FIG. 13;

FIG. 16 shows a perspective part cut-away view of the connector assembly first shown in FIG. 1 but now after the second terminator has been rotated relative to the end connector and showing the next stage on from FIG. 13 of the connection of the second terminator to its respective end connector,

FIG. 17 shows a schematic end view of the connector assembly of FIG. 16, with the cross-sectional lines labelled L corresponding to the cut-away sections of FIGS. 16 and 18;

FIG. 18 shows a schematic part cut-away side view of the connector assembly of FIG. 16;

FIG. 19 shows a perspective part cut-away view of the connector assembly first shown in FIG. 1, fully made up and therefore in a similar configuration to that shown in Figure

FIG. 20 shows a schematic end view of the connector assembly of FIG. 19, with the cross-sectional lines labelled M corresponding to the cut-away sections of FIGS. 19 and 21;

FIG. 21 shows a schematic part cut-away side view of the connector assembly of FIG. 19;

FIG. 22 shows the connector assembly of FIG. 1 with a first example of a locking device installed;

FIG. 23 shows the connector assembly of FIG. 1 with a second example of a locking device installed;

FIG. 24 shows the connector assembly of FIG. 1 with a third example of a locking device installed.

### DETAILED DESCRIPTION

Referring to the drawings, a connector assembly 1 includes a central adaptor 10 having a body with a longitudinal axis x-x, and at least two terminators 40, each terminator 40 having a body with a longitudinal axis y-y. In this example, the central adaptor 10 has two end connectors 20, axially spaced from one another, each end connector 20 projecting outwardly in opposite directions form the central adaptor 10, that each connect to a respective terminator 40. Each terminator 40 connects the central adaptor 10 to respectively and similarly sized interface or connection (not shown) provided on the end of a line such as a hose or a pipe (not shown) which typically carries fluid such as high pressure liquids or gases. When the connection is fully made up, the central adaptor 10 is connected to two lines via the terminators 40, and bridges the lines so that fluid can flow between them. The connector assembly 1 is preferably provided in a kit form (not shown) such as in a protective work case or flight case and comprises at least one central adaptor 10 and a plurality of terminators 40, which are preferably provided with different diameters and connection profiles, for example threaded profiles, such that an operator has the ability, with the complete connector assembly 1, to connect the interface or connection provided on lines of different diameters and/or threaded profiles. Optionally the end of the terminator 40 that connects to the line or hose may be angled at 0-90° relative to the longitudinal axis of the central adaptor. This allows, for example, an elbow connection (not shown) to be made up.

Optionally the connector assembly 1 can be used for lines communicating at high pressures of fluids, i.e. liquids and/or gases. Optionally the connector assembly 1 can be used for lines pressured up to 10,000 psi (approximately 69 MPa), or optionally up to 15,000 psi (approximately 103 MPa), but the invention may be used with lines of higher or lower pressure.

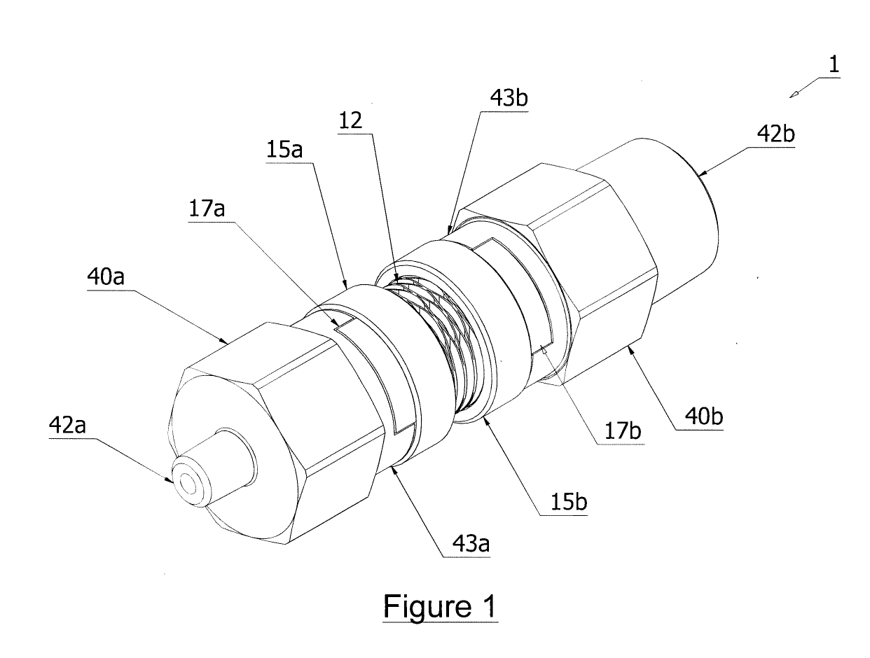

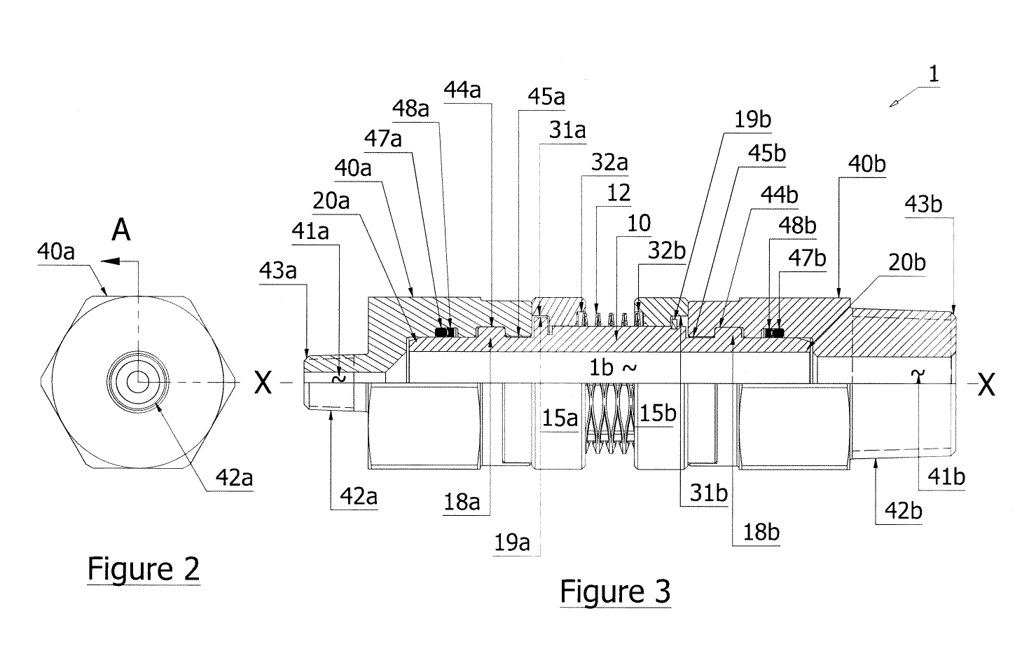

FIGS. 1-3 show an example of the connector assembly 1 with two terminators 40a, 40b, connected to end connectors 20a, 20b, respectively. Each terminator 40a, 40b has a male threaded section 42a, 42b extending from their outer faces, i.e. the faces that are directed away from the central adaptor 10. In this example, threaded section 42a has a significantly smaller diameter than threaded section 42b, allowing two lines of very different internal diameters to be connected together in fluid communication with each other through bore 1b in the central adaptor 10, and bores 41a, 41b in the terminators 40a, 40b respectively. Ordinarily, if the user did not have an adaptor with the correct diameters already in their possession, one would have to be ordered, and potentially manufactured, depending on how common the dimensions of the lines were. This can lead to substantial lead times between the ordering of the adaptor and the delivery. One benefit of the present assembly is that it provides an immediate solution, designed to be put in place temporarily during the wait for a bespoke adaptor, and thus reduce any delay in operations. It may also be an advantageous way of connecting tests lines for e.g. calibration services, where connections may be different for every customer or project, and where some connections may only be made for a few minutes before disconnection and reconnection of a different connection.

The connector assembly 1 comprises a resilient device in the form of spring 12. In this example, spring 12 is a wave spring, but other springs and other suitable forms of resilient device may be substituted, for example a coil spring or elastomer ring.

Each end connector 20a, 20b, has a movable sleeve 15a, 15b, surrounding a relatively central portion of the end connector 20a, 20b. The sleeves 15a, 15b slide over the body of the central adaptor 10, with axial movement towards the centre of the central adaptor 10 limited by the spring 12. The spring 12 biases each movable sleeve 15a, 15b, away from the centre of the central adaptor 10, and axial movement of each movable sleeve 15a, 15b, away from the centre of the central adaptor 10 is limited by retaining rings 19a, 19b, against which each movable sleeve 15a, 15b, abuts. The retaining rings 19a, 19b can be integrally formed with the body of the central adaptor 10 (such as 19a as shown in FIG. 3), or can be a separate component, for example a circlip or similar (such as 19b as shown in FIG. 3). Preferably, one retaining ring 19a is integrally formed and the other retaining ring 19b is a separate component to aid assembly of the central adaptor. Firstly, in this example, movable sleeve 15a, then spring 12, then movable sleeve 15b, and lastly circlip 19b are installed onto the central adaptor 10. The movable sleeves 15a, 15b can each optionally have an annular recess or groove cut in one end of the movable sleeve 15a, 15b, to house the respective end of the spring 12, and can optionally also have an annular recess or groove 31a, 31b formed in the opposing side of the movable sleeve 15a, 15b, to house and abut against the retaining ring 19a, 19b.

In this example, the end connectors 20a, 20b of the central adaptor 10 are male and adapted to receive a female end of each terminator 40a, 40b. However, the end connectors of the central adaptor can also be female with male terminators.

Optionally the terminators 40, the movable sleeves 15, and the central adaptor 10 are manufactured from the same material, for example metal like steel, or composite materials. Optionally one or more components are made from a different material than the others.

Each terminator 40a, 40b has a pin end 43a, 43b, which is shaped for insertion into the box-shaped end of the appropriate line it is intended for connection with, where said pin end 43a, 43b, projects away from the central adaptor 10 coincident with the longitudinal axis x-x thereof. Each pin end 43a, 43b comprises a threaded portion 42a, 42b on the outer circumferential frusto-conical face. The threaded portions 42a, 42b can be attached to respective lines to connect the lines in fluid communication with each other via the bore 1b of the central adaptor 10 when the connector assembly 1 is made up.

The lines may be, for example, fluid transport lines operating at high pressure, e.g. hydraulic or pneumatic lines.

The terminators could also be inserted within the end of a respective line, and one or both of the lines brought into close proximity with or offered up to the central adaptor 10 with the respective terminators included. This would result in the connection of the terminator and the line to the central adaptor 10 being a single step. This arrangement offers the advantage that the lines are then restricted to connecting with the central adaptor 10 only, and can be used, for example, as test lines.

In this example the mating surfaces of the connections between the end connectors 20a, 20b and the terminators 40a, 40b are of a bayonet style. The central adaptor 10 has at least one, preferably two or more a semi-annular ridges 18a, 18b formed in the body of the central adaptor 10 and extending partially around the circumference of the end connector 20a, 20b. The terminator 40a, 40b has at least one axially-extending tab 43a, 43b (see FIG. 6) which has a semi-annular groove 44a, 44b formed on its inner surface. Optionally the at least one axial tab 43a, 43b of the terminator 40a, 40b fits into at least one cut-out portion of the movable sleeve 15a, 15b, formed between two similarly axially protruding tabs 17a, 17b on the sleeve 15a, 15b.

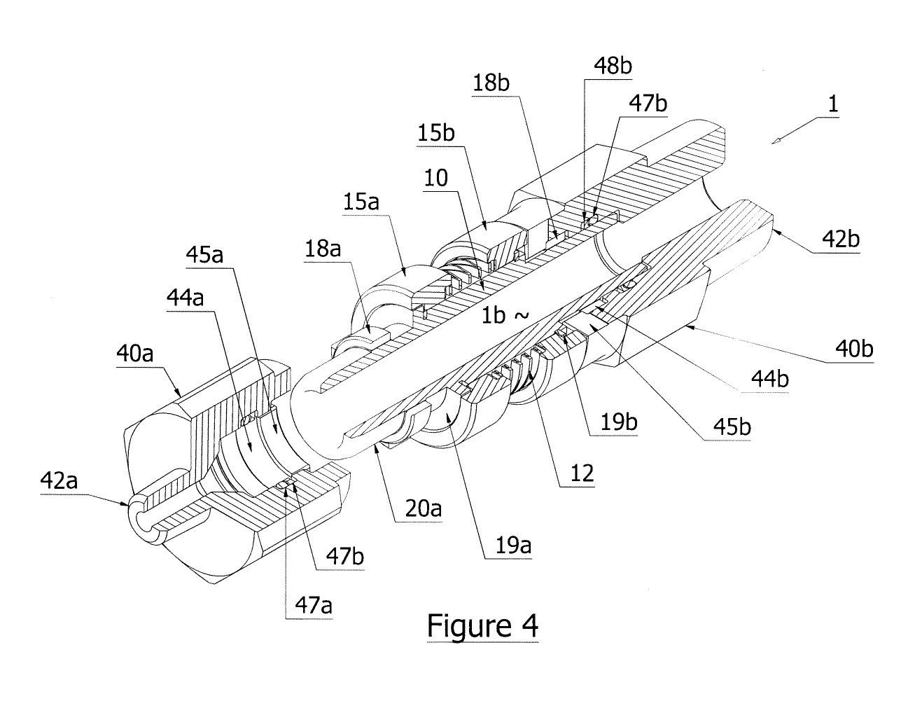

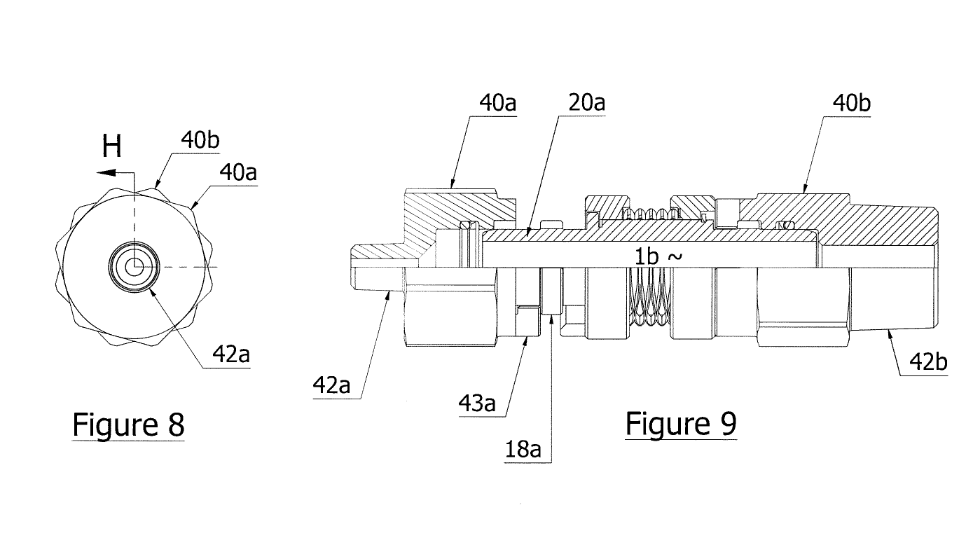

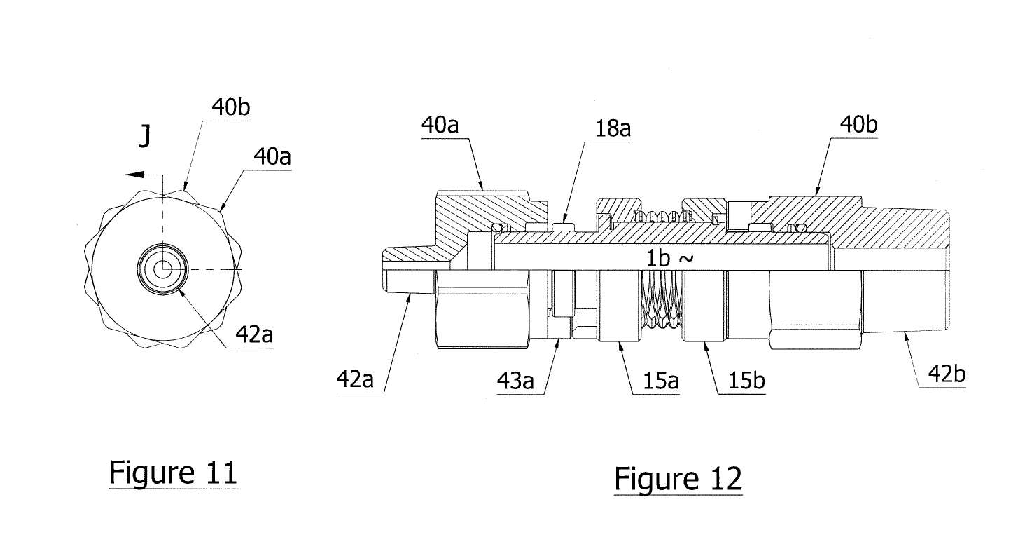

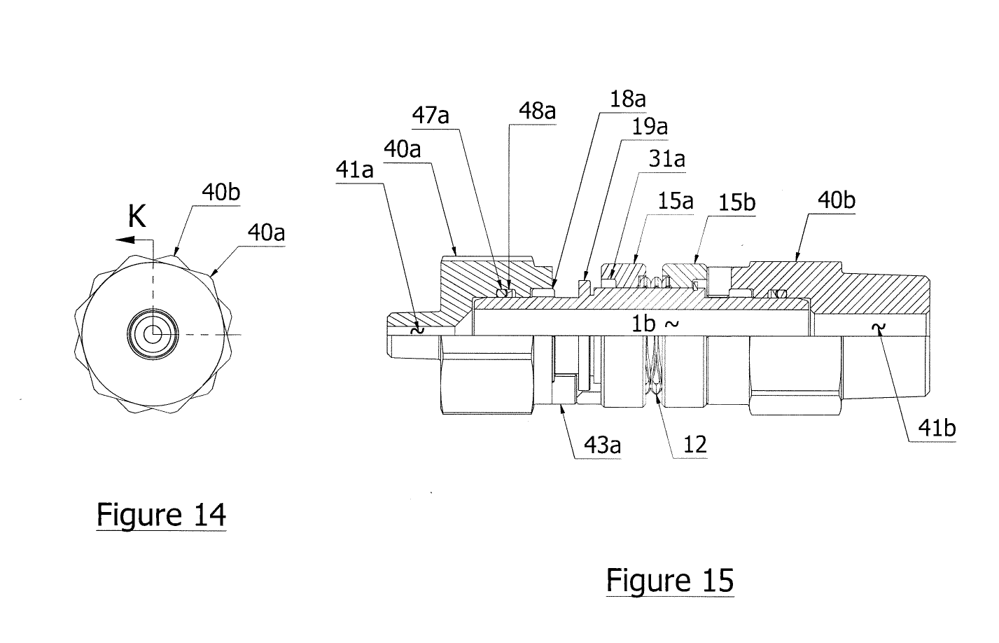

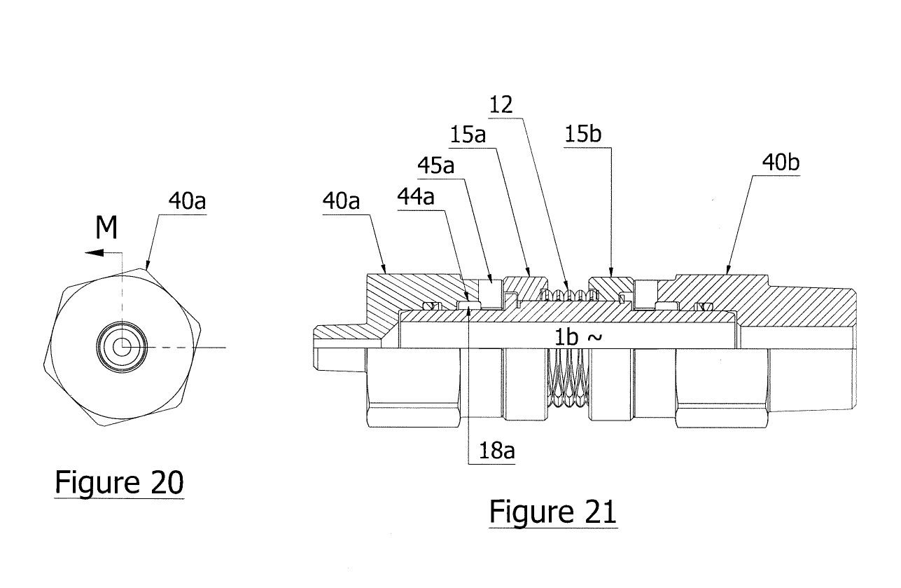

FIGS. 4-21 show the step-by-step process of engaging a terminator with the central adaptor and locking it on to make up the connector assembly.

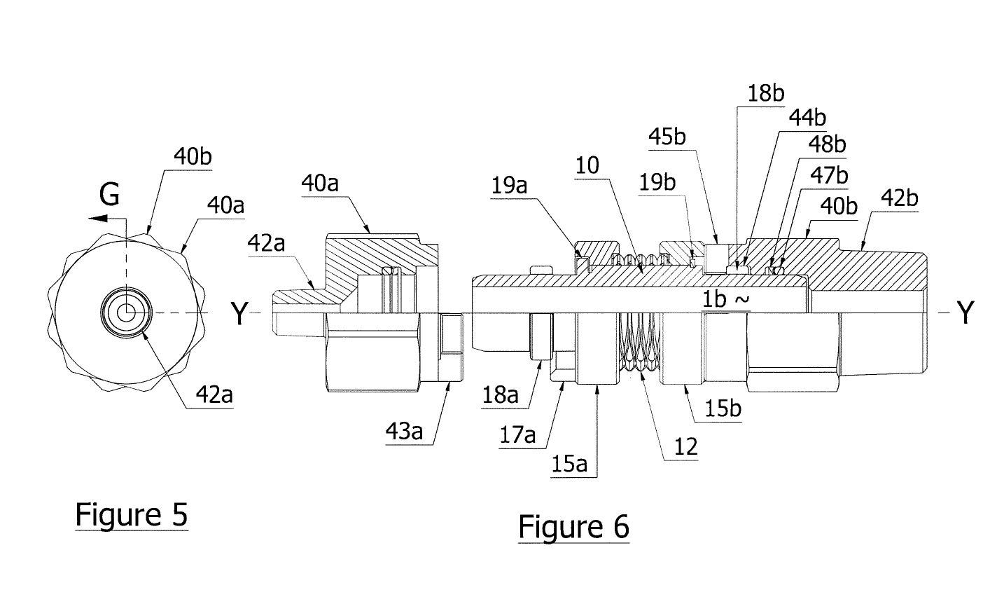

In FIGS. 4-6, terminator 40b is already connected and locked on to the central adaptor 10 via the end connector 20b. Terminator 40a is about to be connected to form the complete connector assembly 1. The end view of FIG. 5 illustrates the rotational offset between connected and locked terminator 40b relative to disconnected and free terminator 40a.

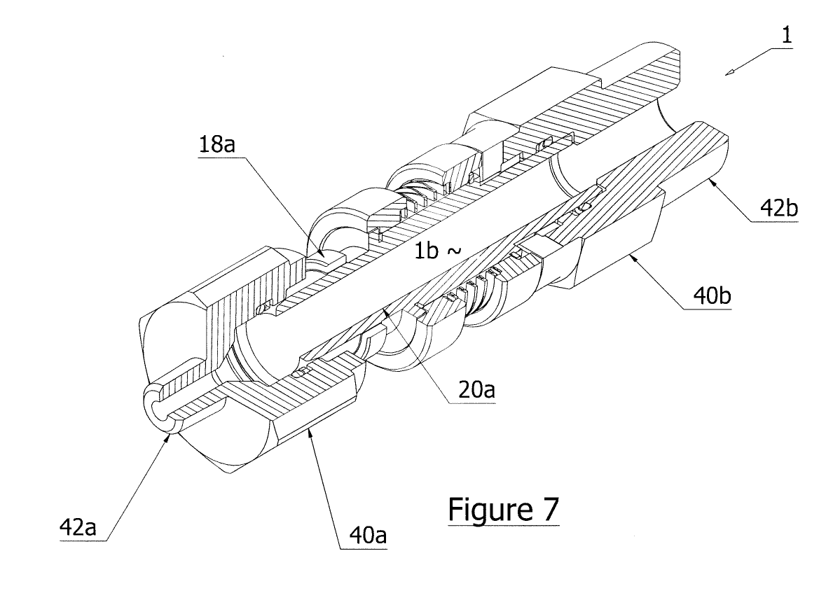

FIGS. 7-9 show the female terminator 40a being slid onto the end connector 20a into its initial position prior to engagement with the adaptor 10, such that the male end connector 20a is inserted into the bore of the female terminator 40a. The distal ends of the end connectors 20a, 20b are preferably angled or chamfered to facilitate entry of the end connectors 20a, 20b, into the bores 41a, 41b ; that is, the angled sections act to guide the end connectors into the bores. The terminator 40a is rotationally and/or axially aligned such that the ridge or ridges 18a is positioned between two axially-protruding tabs 43a formed on the terminator 40a. The tabs each have lips 45a (not shown in FIGS. 7-9 due to the positioning of the terminator). For reasons described below, the lips 45a do not have sufficient radial clearance to pass over the ridges 18a.

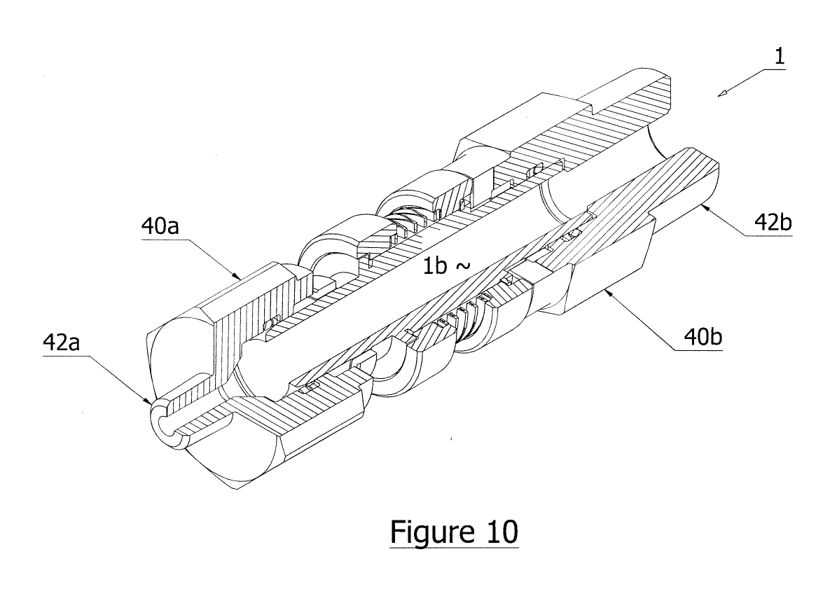

FIGS. 10-12 show the terminator 40a slid further along the end connector 20a in an axial direction toward the centre of the central adaptor 10. As terminator 40a continues to be moved towards the centre of the central adaptor 10, the ridge 18a is positioned into the circumferential space between two axially protruding tabs 43a.

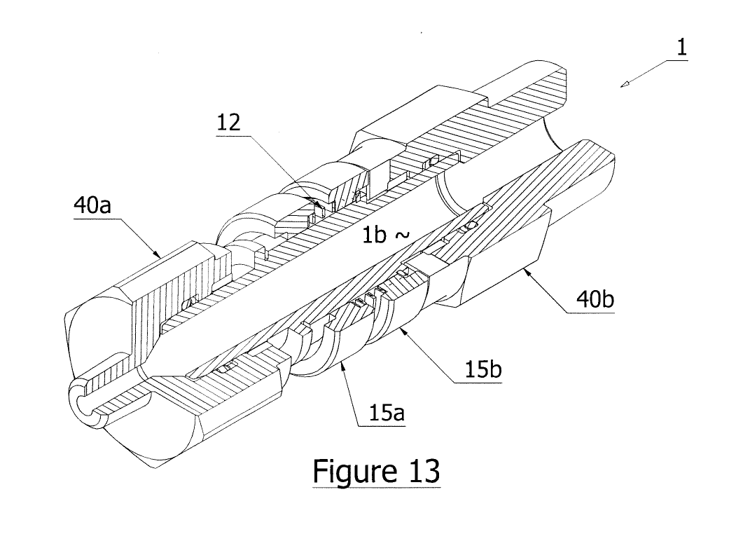

FIGS. 13-15 show the terminator 40a being pushed yet further onto the central adaptor 10 toward the centre thereof. The movable sleeve 15a is moved, or forced by the user, axially away from the end connector 20a, against the biasing force of the spring 12. The spring 12 is thereby compressed and energised by the retraction of the movable sleeve 15a. Retraction of the movable sleeve 15a moves the axial tabs 17a on the sleeve away from the terminator 40a, creating the axial space required to push the terminator 40a fully onto the end connector 20a. The movable sleeve 15a can be retracted manually by pulling it towards the centre of the central adaptor 10. In alternative versions of the movable sleeve, it may be pushed back as a terminator is installed onto the central adaptor, or a tool or clamp could be used to assist with the retraction of the movable sleeve. The end connector 20a is received within the bore of the terminator 40a. The distal end of the end connector 20a is slightly angled away from the walls of the bore, which eases passage of the components relative to one another and reduces the likelihood of damage to the seals 47a, 48a. The seals 47a, 48a form a sealing engagement with the outer surface of the end connector 20a to restrict the potential leakage of fluid around the end connector 20a.

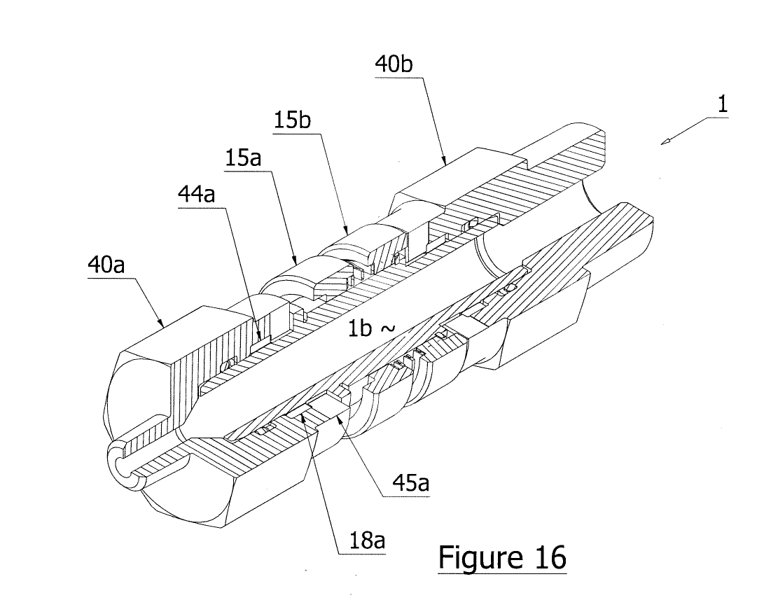

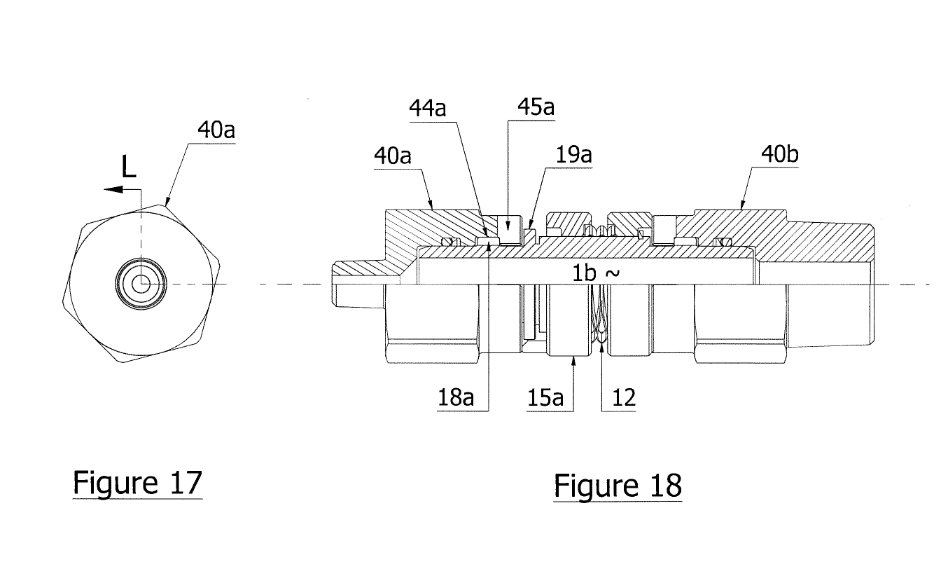

FIGS. 16-18 show the next stage on from FIGS. 13-15 in that they show the terminator 40a being rotationally locked into position. Compare, for example, the alignment between terminators 40a, 40b in FIG. 14 and the alignment in FIG. 17.

The terminator 40a is rotated relative to the body of the central adaptor 10 such that the semi-annular groove 44a on the inner surface of the tab 43a of the terminator 40a rotates over the semi-annular ridge 18a on the body of the central adaptor 10. The tab 43a has a lip 45a that forms one side of the groove 44a. The resulting inter-engagement of the ridge 18a and groove 44a locks the terminator 40a in the axial direction and resists disconnection of the terminator 40a from the central adaptor 10 under axial loading.

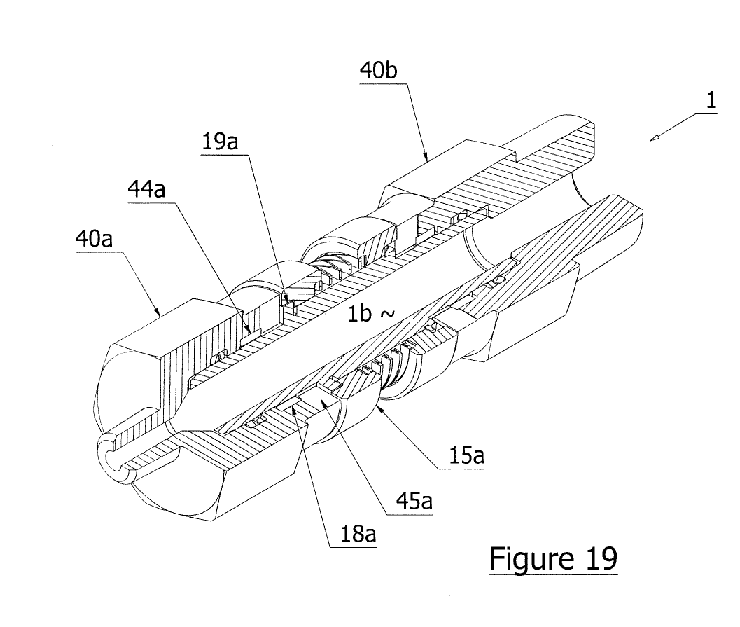

Each tab 43a of the terminator 40a is aligned with each cut-out between axially protruding tabs 17a in the movable sleeve 15a so that when movable sleeve 15a is returned to its original configuration, the tab 43a slides into the cut-out. FIGS. 19-21 show the complete connector assembly 1 after the movable sleeve 15a has been returned to its original position. The inter-engagement of the tab 43a with the cut-out sections resists unwanted or unintended rotational movement of the terminator 40a and the movable sleeve 15a relative to the central adaptor 10. By engaging the terminator 40a with the sleeve 15a, rotational movement of the sleeve 15a is also restricted.

Accordingly, once the terminator 40a has been connected to the central adaptor 10, both axial and rotational movement of the terminator 40a relative to the central adaptor 10 is restricted. The bores 41a, 41b, and 1 b are connected in a sealed manner such that no fluid contained within the bores 41a, 41b, and 1b, can escape to the outer environment through the connections in the connector assembly 1 and are thus ready for transfer of fluids through the connector assembly 1.

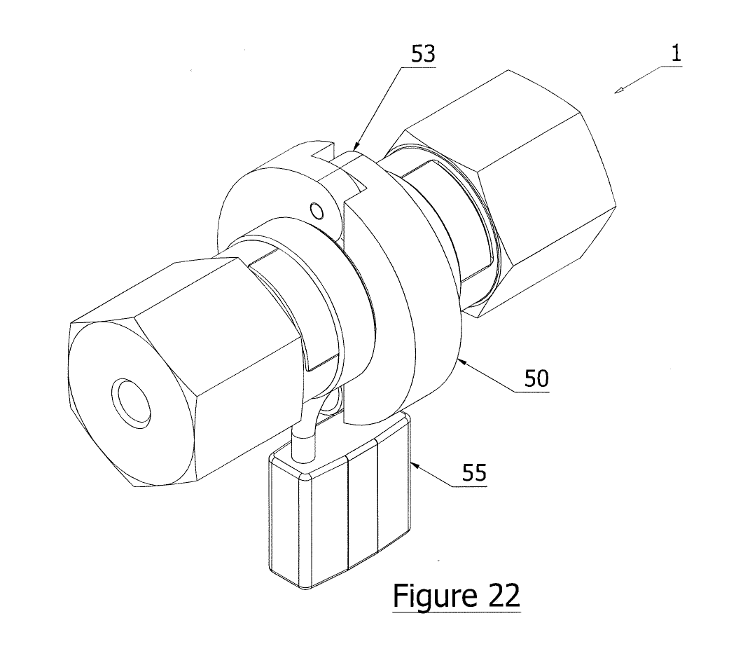

Optionally a locking device may be placed between the movable sleeves 15a, 15b of each end connector 20a, 20b to resist axial movement of the movable sleeves 15a,15b, and thereby prevent accidental disconnection of the terminators 40a, 40b. FIGS. 22-24 show three possible examples of locking devices 50, 60, 65 that can be used with the connector assembly 1.

FIG. 22 shows one example of a suitable locking device in the form of a clamp 50 which clamps over the spring 12, between the movable sleeves 15a, 15b. Additional reinforcement of this may be provided in the form of, for example, a padlock 55 to resist the clamp disconnecting. The clamp 50 has two halves connected at a hinge 53, wherein one half comprises an extending tongue at one end with an aperture therethrough (not shown), where the tongue is received into a slot at the end of the other half of the clamp 50, the slot having apertures through each side. The apertures in the tongue and the slot may line up and permit the insertion of a shackle through said apertures to resist the tongue moving out of the slot.

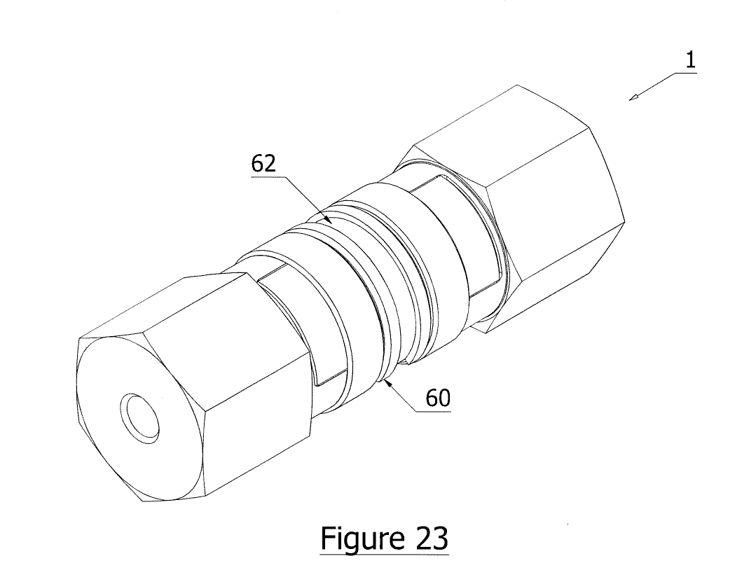

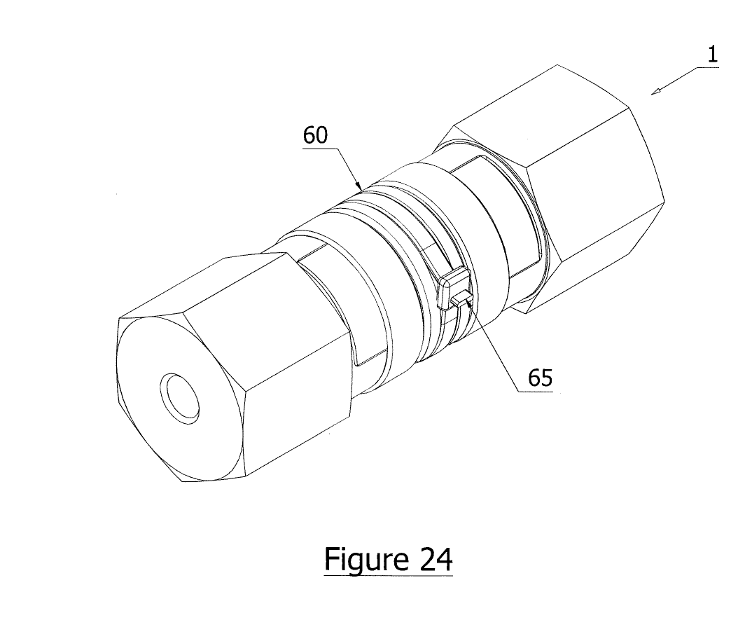

FIG. 23 shows a second example of a suitable locking device in the form of a semi-annular ring 60 that clips over the spring 12, between the movable sleeves 15a, 15b. The ring may be made of plastic. The ring may have a central groove 62. While the semi-annular ring 60 may be used by itself, as shown in FIG. 24, a cable tie 65 may be placed into the groove 62 and tightened to reinforce the ring 60 and prevent the ring 60 becoming loose, and potentially detaching from the connector assembly 1.

The central adaptor 10 and its terminators 40 are preferably provided in a kit form (not shown) such as in a protective flight case, or tool chest, or similar container. The kit preferably comprises one central adaptor 10, but can contain more than one such as two central adaptors 10, and a plurality of terminators 40. In one example, the kit can contain between 10 and 50 terminators, offering a range of 45-1225 possible connection combinations, calculated as follows

n=number of different terminators in the kit

r=number of terminators that will be combined (for a double-ended central adaptor, this is always 2)

ₙCᵣn!/r!(n−r)! (1)

Hence for a kit with a single double-ended adaptor and 10 terminators, there are

ₙCᵣ=10!/2!(10−2)!=45 possible combinations;

and for a kit with a single double-ended adaptor and 50 terminators, there are

ₙCᵣ=50!/2!(50−2)!=1225 possible combinations.

The kit may contain fewer terminators, or more, depending on the requirements of the operator.

The terminators 40 are preferably provided with different diameters and/or threaded connection profiles. Each terminator 40 can be connected to the central adaptor 10 in combination with any other terminator 40 to create a bespoke combination of diameters and/or threaded connection profiles. The operators thus have a “library” of terminators 40 that can be selected from to form a connector assembly 1 suitable for connecting a multitude of hoses or lines. The kit can also include at least one whip hose or similar conduit which may provide an extension between the end of the line to be connected and the connector assembly.

A single kit can therefore remove or greatly reduce the need to keep an extensive collection of adaptors on site, and where the wait for bespoke adaptors to be manufactured would ordinarily potentially create an undesirable and costly delay in operations, the kit may be used to temporarily connect lines until a more permanent replacement adaptor arrives.

Modifications and improvements may be made to the embodiments hereinbefore described without departing from the scope of the invention.

1. A kit comprising a connector assembly for connecting at least two separate lines together in fluid communication, the connector assembly comprising:
a central adaptor having a bore therethrough; and
at least a first terminator and a second terminator, each terminator having a bore therethrough;
wherein the central adaptor comprises at least a first end connector and a second end connector, the at least first and second end connectors being spaced from one another, each end connector being adapted to connect to a terminator, wherein each terminator is adapted to permit the connector assembly to be connected with said at least two separate lines such that the said lines are in fluid communication when the connector assembly is made up,
wherein the kit further comprises at least a third said terminator;
wherein each terminator comprises a standard first coupling on one side, wherein said standard first coupling is adapted to permit each terminator to be connected to either end connector of the central adaptor;
and each terminator further comprises a second coupling on another side of the terminator, the second coupling permitting connection to a line having a particular diameter; and
wherein the at least three terminators in the kit comprise a range of diameters and/or connection types for connection with a respective range of lines.

2. A kit as claimed in claim 1, wherein the at least one central adaptor and the at least three terminators are wholly contained for storage and/or transportation within a single protective container.

3. A kit as claimed in claim 1, wherein each second coupling is unique within the kit.

4. A kit as claimed in claim 1, wherein the number of potential combinations provided by the kit is provided by the formula ₙCᵣ=n!/r!(n−r)!, wherein n is the number of different terminators within the kit, and r is the number of terminators that will be combined with the central adaptor.

5. A kit as claimed in claim 1, wherein the first and second end connectors of the central adaptor are male and are adapted to be received within a bore of a female end of each terminator.

6. A kit as claimed in claim 1, wherein each terminator comprises a threaded portion adapted to connect a line to the central adaptor when the connector assembly is made up.

7. A kit as claimed in claim 1, wherein each of the first and second end connectors comprise a movable sleeve adapted to slide axially over an outer surface of the central adaptor.

8. A kit as claimed in claim 7, wherein the axial travel of each movable sleeve is restricted in a first axial direction by a retaining device.

9. A kit as claimed in claim 8, wherein at least one retaining device is integrally formed on the outer surface of the central adaptor.

10. A kit as claimed in claim 8, wherein the movable sleeves comprise at least one annular recess adapted to receive the retaining device.

11. A kit as claimed in claim 7, wherein a locking device is placed between the movable sleeves of each end connector to resist axial movement of the sleeves towards the centre of the central adaptor.

12. A kit as claimed in claim 7, wherein the central adaptor comprises a resilient device disposed between the movable sleeves and is mutually acting on each movable sleeve and biases each movable sleeve axially away from the centre of the central adaptor.

13. A kit as claimed in claim 12, wherein the axial travel of each movable sleeve is restricted in a second axial direction by the resilient device.

14. A kit as claimed in claim 12, wherein the movable sleeves comprise at least one annular recess adapted to receive at least an end portion of the resilient device.

15. A kit as claimed in claim 12, wherein the movable sleeve is adapted to be retracted in opposition to the biasing force of the resilient device, wherein retraction of the movable sleeve towards the centre of the central adaptor extends the axial distance by which the terminator may be pushed onto the end connector until the male portion of the end connector is fully inserted into the bore of the terminator.

16. A kit as claimed in claim 12, wherein each movable sleeve comprises an axially protruding portion extending in an axial direction away from the resilient device, wherein the axially protruding portion comprises at least one cut-out.

17. A kit as claimed in claim 1, wherein the central adaptor comprises at least one semi-annular radially protruding ridge formed on an outer surface of the central adaptor that extends partially around the circumference of the first and second end connectors of the central adaptor, wherein the terminator comprises at least one axially-extending tab comprising a complementary semi-annular grooved section on an inner surface;
wherein during connection of the terminator to one of the first or second end connectors, the terminator is aligned so that the at least one semi-annular radially protruding ridge on the central adaptor is positioned between two axially-protruding tabs formed on the terminator;
wherein the terminator is rotatable relative to the end connector such that the semi-annular grooved section on the inner surface of the terminator rotates over at least one semi-annular radially protruding ridge on the central adaptor;
wherein the semi-annular grooved section on the inner surface of the terminator inter-engages with the semi-annular radially protruding ridge on the central adaptor and resists relative axial movement of the terminator and the central adaptor;
wherein the at least one tab of the terminator is adapted to fit into at least one cut-out in a protruding annular portion of a movable sleeve; and
wherein at least one axially-extending tab of the terminator is aligned with at least one cut-out in the movable sleeve such that as the movable sleeve returns to its original resting configuration, the tab is received within the cut-out.

18. A kit as claimed in claim 1, wherein the bore of each terminator comprises at least one flat portion extending longitudinally therein, and each end connector comprises a corresponding flat portion extending longitudinally on the outer surface thereof; and wherein upon connection of the terminator to the end connector the corresponding flat portions engage and restrict relative rotational movement.

19. A kit as claimed in claim 1, wherein each terminator has at least one sealing device disposed on an inner surface of the bore of the female connector adapted to seal against ingress of fluid or debris.

20. A kit as claimed in claim 1, wherein at least one terminator is disposed within the end portion of a bore of a line.

21. A connector assembly for connecting at least two separate lines together in fluid communication, the connector assembly comprising:
a central adaptor having a bore therethrough; and
at least two terminators, each terminator having a bore therethrough;
wherein the central adaptor comprises at least a first end connector and a second end connector, the at least first and second end connectors being spaced from one another, each end connector being adapted to connect to a terminator,
wherein each terminator is adapted to permit the connector assembly to be connected with said at least two separate lines such that the said lines are in fluid communication when the connector assembly is made up;
wherein each of the first and second end connectors comprise a movable sleeve adapted to slide axially over an outer surface of the central adaptor; and
wherein the central adaptor comprises a resilient device that is disposed between the movable sleeves and is mutually acting on each movable sleeve.

22. A connector assembly as claimed in claim 21, wherein the first and second end connectors of the central adaptor are male and are adapted to be received within a bore of a female end of each terminator; and
wherein each terminator comprises a threaded portion adapted to connect a line to the central adaptor when the connector assembly is made up.

23. A connector assembly as claimed in claim 21, wherein the axial travel of each movable sleeve is restricted in a first axial direction by a retaining device.

24. A connector assembly as claimed in claim 21, wherein the movable sleeves comprise at least one annular recess adapted to receive the retaining device.

25. A connector assembly as claimed in claims 21, wherein a locking device is placed between the movable sleeves of each end connector to resist axial movement of the sleeves towards the centre of the central adaptor.

26. A connector assembly as claimed in claim 21, wherein the resilient device biases each movable sleeve axially away from the centre of the central adaptor; and wherein the axial travel of each movable sleeve is restricted in a second axial direction by the resilient device.

27. A connector assembly as claimed in claim 21, wherein the movable sleeves comprise at least one annular recess adapted to receive at least an end portion of the resilient device.

28. A connector assembly as claimed in claim 21, wherein the movable sleeve is adapted to be retracted in opposition to the biasing force of the resilient device, wherein retraction of the movable sleeve towards the centre of the central adaptor extends the axial distance by which the terminator may be pushed onto the end connector until the male portion of the end connector is fully inserted into the bore of the terminator; and
wherein each movable sleeve comprises an axially protruding portion extending in an axial direction away from the resilient device, wherein the axially protruding portion comprises at least one cut-out.

29. A connector assembly as claimed in claim 21, wherein the central adaptor comprises at least one semi-annular radially protruding ridge formed on an outer surface of the central adaptor that extends partially around the circumference of the first and second end connectors of the central adaptor;
wherein the terminator comprises at least one axially-extending tab comprising a complementary semi-annular grooved section on an inner surface;
wherein during connection of the terminator to one of the first or second end connectors, the terminator is aligned so that the at least one semi-annular radially protruding ridge on the central adaptor is positioned between two axially-protruding tabs formed on the terminator;
wherein the terminator is rotatable relative to the end connector such that the semi-annular grooved section on the inner surface of the terminator rotates over at least one semi-annular radially protruding ridge on the central adaptor;
wherein the semi-annular grooved section on the inner surface of the terminator inter-engages with the semi-annular radially protruding ridge on the central adaptor and resists relative axial movement of the terminator and the central adaptor;
wherein the at least one tab of the terminator is adapted to fit into at least one cut-out in a protruding annular portion of a movable sleeve; and
wherein at least one axially-extending tab of the terminator is aligned with at least one cut-out in the movable sleeve such that as the movable sleeve returns to its original resting configuration, the tab is received within the cut-out.

30. A method of connecting at least two separate lines having different internal diameters and/or different connection profiles to each other, the method including:
i) providing a kit according to claim 1;
ii) connecting each end connector of the central adaptor to the standard first coupling on a respective terminator to make up the connector assembly, wherein each terminator comprises a standard first coupling on one side, wherein said standard first coupling is adapted to permit each terminator to be connected to either end connector of the central adaptor;
and each terminator further comprises a second coupling on another side of the terminator, the second coupling permitting connection to a line having a particular diameter; and
iii) connecting each terminator of the connector assembly with a respective line such that the at least two separate lines are in fluid communication.
